(19) United States
(12) Patent Application Publication
(10) Pub. No.: US 2024/0181970 A1
(43) Pub. Date: Jun. 6, 2024

(54) VEHICLE COVERING SHELF FIXTURE APPARATUS

(71) Applicants: HYUNDAI MOTOR COMPANY, SEOUL (KR); KIA CORPORATION, SEOUL (KR); SEOYON E-HWA CO., LTD., Anyang-si (KR)

(72) Inventors: Seung Kun LEE, Suwon-si (KR); Seok Cheol KIM, Suwon-si (KR); Jin Seok YOON, Seoul (KR); Tae Wook HONG, Uiwang-si (KR)

(21) Appl. No.: 18/515,209

(22) Filed: Nov. 20, 2023

(30) Foreign Application Priority Data
Dec. 1, 2022 (KR) 10-2022-0165933

(51) Int. Cl. B60R 5/04

(52) U.S. Cl. CPC B60R 5/045

(57) ABSTRACT

A vehicle comprising a luggage side trim provided at each of both sides of a storage space provided behind a seat inside the vehicle and a covering shelf configured to selectively cover the storage space, is provided. The covering shelf may comprise a first hinge groove on each of both sides at a front end, and the luggage side trim may comprise a first hinge protrusion configured to be coupled to the first hinge groove and a fixing means configured to fix the covering self.

### CROSS-REFERENCE OF RELATED APPLICATIONS

This application claims the benefit of Korean Patent Application No. 10-2022-0165933, filed on Dec. 1, 2022, which is hereby incorporated by reference as if fully set forth herein.

### TECHNICAL FIELD

The present disclosure relates to a covering shelf fixture apparatus that covers a luggage space used in a hatchback vehicle.

### BACKGROUND

A hatchback vehicle refers to a vehicle having a door (i.e., a tailgate) that is opened and closed upward and downward at the back of the body. Unlike a sedan, it has no separate trunk but uses a space between the rear seat and the tailgate for loading. Such a loading space has a relatively great height and the space may be expanded by folding down the rear seat, and may thus be of practical use as it allows large items to be loaded as needed.

However, not all items are so large that the rear seat needs to be folded down; some items having heights lower than that of the seatback (or backrest) of the rear seat may generally be stored in a luggage space. However, these items stored in the luggage space may be visible from the outside, increasing the risk of being stolen. In addition, if the items are poorly organized, they may compromise the vehicle's appearance.

To solve the foregoing issues, a covering shelf may be installed in the luggage space of the hatchback vehicle. However, to load items larger than the height of the installed covering shelf, once the covering shelf is installed, it is necessary to temporarily remove the covering shelf. To this end, a typical coupling method through forced fitting between the rear seat and a luggage side trim (indicated as a red arrow) as shown in FIG. 16, or a typical method of mounting the shelf on the back of the backrest of the rear seat via a rail (indicated in red) formed on the luggage side trim as shown in FIG. 17 has been used.

When removing the covering shelf to mount it on the back of the backrest of the rear seat or remove it therefrom, such methods may, however, not readily remove the shelf due to a limited space in the luggage space.

The foregoing description of the background is intended to provide a better understanding of the background of the present disclosure and should not be construed as an admission that the present disclosure corresponds to the prior art already known to one having ordinary skill in the art to which the present disclosure pertains.

### SUMMARY

Various aspects of the present disclosure are directed to providing a vehicle comprising a novel shelf fixture covering apparatus that allows a covering shelf to be readily mounted to and removed from a back surface of a backrest of a rear seat.

A vehicle, according to one embodiment of the present disclosure, comprises a luggage side trim provided at each of both sides of a storage space provided rearwardly from a seat inside the vehicle and a covering shelf configured to selectively cover the storage space, wherein the covering shelf comprises a first hinge groove on each of both sides at a front end, and the luggage side trim comprises a first hinge protrusion configured to be coupled to the first hinge groove and a fixing means configured to fix the covering self.

In at least one embodiment of the present disclosure, the luggage side trim further comprises a second hinge protrusion spaced from the first hinge protrusion by a predetermined distance, and the covering shelf further comprises a second hinge groove provided on each of both sides at a rear end of the covering shelf.

In at least one embodiment of the present disclosure, the luggage side trim further comprises a seating portion configured to allow the covering shelf to be placed on to cover the storage space, and wherein the second hinge protrusion is positioned at a same height as the seating portion.

In at least one embodiment of the present disclosure, the seating portion and the second hinge protrusion are spaced from each other by a predetermined distance in a horizontal direction.

In at least one embodiment of the present disclosure, the fixing means is positioned between the first hinge protrusion and the second hinge protrusion.

In at least one embodiment of the present disclosure, the fixing means comprises a fixing protrusion extending from an inner surface of the luggage side trim.

In at least one embodiment of the present disclosure, the fixing means comprises a magnetic body provided on the luggage side trim and wherein the covering shelf further comprises a portion made of a material which is able to be adhered to the magnetic body by magnetic force.

In at least one embodiment of the present disclosure, the covering shelf further comprises a reinforcing portion on which the first hinge groove is formed.

In at least one embodiment of the present disclosure, the first hinge groove is formed diagonally from a bottom, and the second hinge groove is formed from top to bottom.

In at least one embodiment of the present disclosure, the fixing means comprises a magnetic body provided on the second hinge protrusion and the covering shelf comprises a portion provided in the second hinge groove and made of a material which is able to be adhered to the magnetic body by magnetic force.

A vehicle, according to one embodiment of the present disclosure, comprises a luggage side trim provided at each of both sides of a storage space provided behind a seat inside the vehicle and a covering shelf configured to selectively cover the storage space, wherein the luggage side trim comprises a hinge protrusion on an upper portion thereof, and the covering shelf comprises a first hinge groove provided on each of both sides at a front end and is configured to be coupled to the hinge protrusion when the covering shelf is placed on a seating portion of the luggage side trim.

In at least one embodiment of the present disclosure, the covering shelf further comprises a second hinge groove provided on each of both sides at a rear end and is configured to be coupled to the hinge protrusion when the covering shelf is placed at a rear surface of a backrest of a rear seat after being separated from the seating portion.

In at least one embodiment of the present disclosure, the luggage side trim further comprises a plurality of support protrusions spaced from the backrest of the rear seat by a predetermined distance.

In at least one embodiment of the present disclosure, the covering shelf further comprises a second hinge groove formed in an opposite direction to the first hinge groove and is configured to be coupled to the hinge protrusion when the covering shelf is separated from the seating portion and placed in a reversed state at a rear surface of a backrest of a rear seat.

In at least one embodiment of the present disclosure, the luggage side trim further comprises a support protrusion spaced from the hinge protrusion by a predetermined distance.

In at least one embodiment of the present disclosure, the luggage side trim further comprises a fixing means configured to fix the covering self to the luggage side trim, the fixing means located between the hinge protrusion and the support protrusion.

When a covering shelf is not in use, it may be held against a back surface of a backrest of a rear seat, and thus a larger volume in a luggage space may be used.

A guide rail for storage of the covering shelf may not be required, which may improve the outer appearance of a luggage side trim, and manufacturing a mold for injection in a simple form may be enabled.

The effects to be obtained from the present disclosure are not limited to those described above, and other effects not described will be apparent to one having ordinary skill in the art to which the present disclosure pertains from the following description.

### BRIEF DESCRIPTION OF THE DRAWINGS

FIG. 1 is a view illustrating a luggage side trim of a covering shelf fixture apparatus according to a first embodiment of the present disclosure.

FIG. 2 is a view illustrating a covering shelf fixture apparatus in which a covering shelf is placed on a luggage side trim according to the first embodiment of the present disclosure.

FIG. 3 is a view illustrating a covering shelf fixture apparatus in which a covering shelf is stored according to the first embodiment of the present disclosure.

FIG. 4a is a view illustrating an example of a covering shelf fixture apparatus according to the first embodiment of the present disclosure.

FIG. 4b is a view illustrating an example of a covering shelf fixture apparatus according to the first embodiment of the present disclosure.

FIG. 4c is a view illustrating an example of a covering shelf fixture apparatus according to the first embodiment of the present disclosure.

FIG. 5 is a view illustrating a first hinge groove and a second hinge groove of a covering shelf of a covering shelf fixture apparatus according to the first embodiment of the present disclosure.

FIG. 6 is a view illustrating a covering shelf fixture apparatus in which a first hinge groove of a covering shelf is coupled according to the first embodiment of the present disclosure.

FIG. 7 is a view illustrating a covering shelf fixture apparatus in which a second hinge groove is coupled while a first hinge groove of a covering shelf is coupled according to the first embodiment of the present disclosure.

FIG. 8 is a view illustrating a covering shelf fixture apparatus in which a covering shelf is placed on a luggage side trim according to a second embodiment of the present disclosure.

FIG. 9 is a view illustrating a covering shelf fixture apparatus in which a covering shelf is being stored according to the second embodiment of the present disclosure.

FIG. 10 is a view illustrating a covering shelf fixture apparatus in which a covering shelf is stored according to the second embodiment of the present disclosure.

FIG. 11 is a view illustrating a hinge protrusion and a support protrusion formed on a luggage side trim of a covering shelf fixture apparatus according to a third embodiment of the present disclosure.

FIG. 12 is a view illustrating a covering shelf fixture apparatus in which a second hinge groove of a covering shelf is stored by being coupled to a hinge protrusion according to the third embodiment of the present disclosure.

FIG. 13 is a rear view illustrating a covering shelf fixture apparatus in which a second hinge groove of a covering shelf is stored by being coupled to a hinge protrusion according to the third embodiment of the present disclosure.

FIG. 14 is a view illustrating a covering shelf fixture apparatus in which a first hinge groove of a covering shelf is placed on a luggage side trim while coupled to a hinge protrusion according to the third embodiment of the present disclosure.

FIG. 15 is a view illustrating a covering shelf fixture apparatus in which a second hinge groove of a covering shelf is stored by being coupled to a hinge protrusion according to the third embodiment of the present disclosure.

FIG. 16 is a view illustrating a typical forced fitting-based covering shelf storage portion according to the related art.

FIG. 17 is a view illustrating a typical rail-based covering shelf storage portion according to the related art.

### DETAILED DESCRIPTION

Hereinafter, embodiments of the present disclosure will be described in detail with reference to the accompanying drawings, and the same or similar elements will be given the same reference numerals regardless of reference symbols, and redundant description thereof will be omitted. The accompanying drawings are used to illustrate various technical features, and it should be understood that the embodiments presented herein are not limited by the accompanying drawings. As such, the present disclosure should be construed to extend to any alterations, equivalents, and substitutes, in addition to those that are particularly set out in the accompanying drawings.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is referred to as being “coupled” or “connected” to another element, the element may be directly coupled or connected to the other element. However, it should be understood that on or more elements may be present therebetween. In contrast, when an element is referred to as being “directly coupled” or “directly connected” to another element, it should be understood that there are no other elements therebetween.

In the description of the embodiments, layers, regions, patterns, or structures being formed “above/on” or “below/under” the substrate, layers, regions, pads, or patterns may be construed such that they are formed directly “on” or “under” the substrate, layers, regions, pads, or patterns, or other layers may be interposed therebetween. In addition, “above/on” or “below/under” may be distinguished as shown in the drawings for convenience only, and be used to conveniently indicate relative positional relationships between components, and should not be construed as limiting the actual positions of the components. For example, “B on A” merely indicates that B is shown on A in the drawings, unless otherwise noted or unless the properties of A or B require that A be located on B. In an actual application to products, B may be located under A, or B and A may be next to each other, for example.

In addition, the thickness or size of any layer, area, pattern, or structure in the drawings may be modified for clarity and convenience of illustration and not necessarily be indicative of actual size.

The terminology used herein is for the purpose of describing particular examples only and is not to be limiting of the examples. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

### First Embodiment

According to at least one embodiment of the present disclosure, a vehicle comprises a covering shelf assembly. The vehicle provide a storage space behind a rear seat in the interior space. The assembly comprises a covering shelf fixture apparatus for fixing a covering shelf 140 to a luggage side trim 100 provided on either side of the storage space. The covering shelf fixture apparatus may comprise a first hinge protrusion 120, the covering shelf 140, and a fixing means 190.

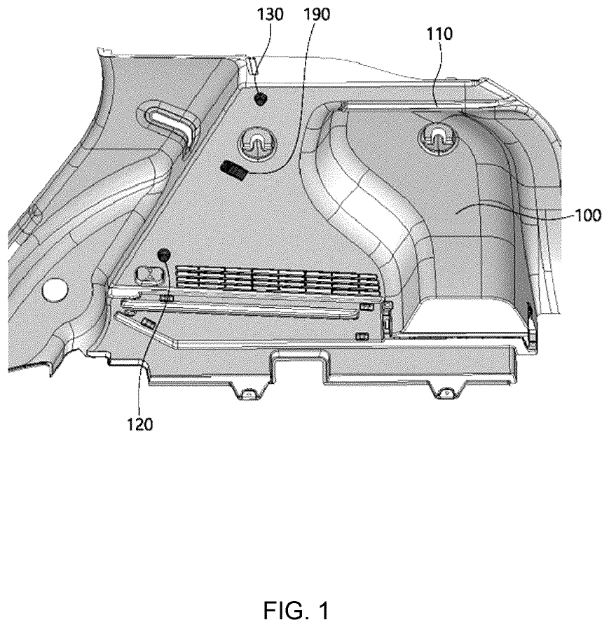

The first hinge protrusion 120 may be formed on the luggage side trim 100 as shown in FIG. 1. The luggage side trim 100 may be provided on each of both sides of the storage space, in other words, a first luggage side trim is placed inside the body of the vehicle to serve as one lateral side wall for the storage space and a second luggage side trim is placed opposite to the first luggage side trim to serve as the other lateral side wall for the storage space. The first and second luggage side trims may be symmetric in configuration to each other, therefore, for the sake of convenience in description, the embodiments of the present disclosure are described with only one luggage side trim. The first hinge protrusion 120 may be formed on the luggage side trim extending inwardly such that the tow first hinge protrusions on the both luggage side trims face each other. The first hinge protrusion 120 may be provided on a lower portion of the luggage side trim 100.

The covering shelf fixture apparatus may further include a second hinge protrusion 130. The second hinge protrusion 130 may be formed on the luggage side trim 100 but be spaced from the first hinge protrusion 120 by a predetermined distance, and may be provided on an upper portion of the luggage side trim 100 as shown in FIG. 1.

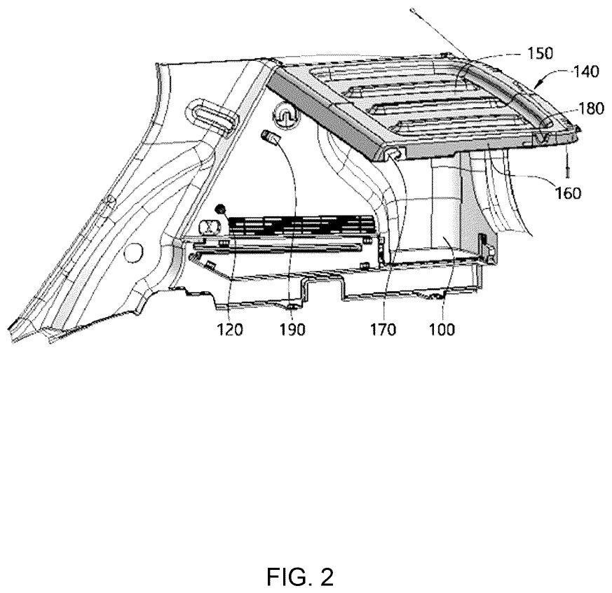

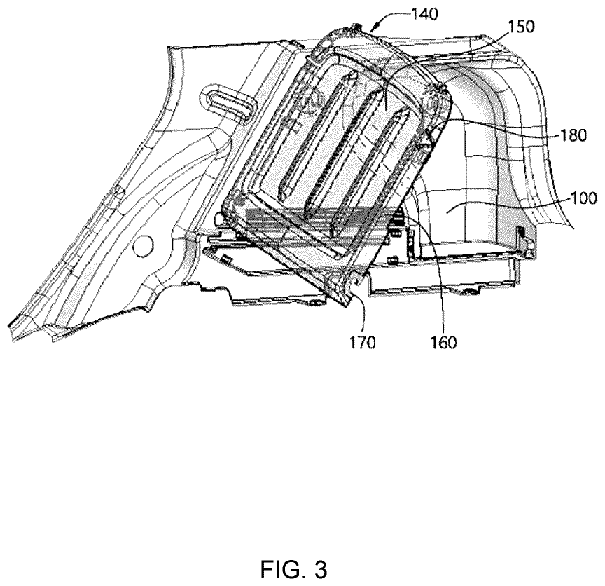

The covering shelf 140 may include a first hinge groove 170 provided on each of both sides at the front end and coupled to the first hinge protrusion 120, as shown in FIGS. 2 and 3. The covering shelf 140 may further include a second hinge groove 180 provided on each of both sides at the rear. The second hinge groove 180 may be coupled to the second hinge protrusion 130 described above.

Specifically, the covering shelf 140 may include a top plate 150 and a sidewall 160 formed in a perpendicular direction from each of both sides of the top plate 150. The first hinge groove 170 and the second hinge groove 180 may be formed on the sidewall 160.

The fixing means 190 may serve to fix the covering shelf 140 to the luggage side trim 100.

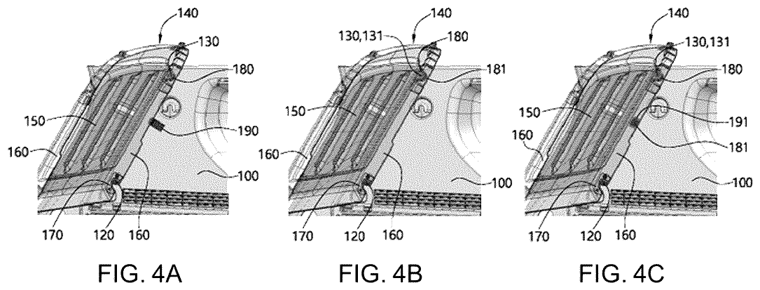

The fixing means 190 may be formed between the first hinge protrusion 120 and the second hinge protrusion 130, as shown in FIG. 4a. The fixing means 190 may include a fixing protrusion provided on the luggage side trim 100. The fixing protrusion may in form of a tension hook comprising a protrusion extending inwardly, i.e. in a direction of the center of the storage space. The tension hook may have a structure which is formed by cutting the luggage side trim 100 at three sides around the protrusion in the form of a squared C shape (“⊏”), thereby being able to be elastically deformed when the protrusion is pressed. when the covering shelf is placed in the unused state, a surface of the hook may elastically press a side rim of the covering shelf 140 and the protrusion of the hook may support an edge of a low end of the side rim when the first hinge groove 170 and the first hinge protrusion 120 are coupled to each other to allow the covering shelf 140 to be disposed on a back surface of a backrest of a rear seat. The covering shelf 140 may be removed from the unused state as the protrusion of the hook is pressed.

In another embodiment of the fixing means 190, a magnetic body 131 may be provided on the second hinge protrusion 130 as shown in FIG. 4b. In this embodiment, the second hinge protrusion 130 may be provided with the magnetic body 131 formed through insert injection therein, and the second hinge protrusion 130 may itself be the magnetic body 131. A magnetic body described herein may be a permanent magnet.

The second hinge groove 180 may be formed in a portion 181 which is made of a material that is able to be adhered to the magnet. The material adhering to the magnet may be a piece of iron plate described above, and may be provided in a “V” shape along a bottom surface of the second hinge groove 180, as indicated by the red line in FIG. 4b and may be formed through insert injection when injection molding is performed on the curving shelf 140. This may allow the second hinge groove 180 to be magnetically fixed to the second hinge protrusion 130 when the second hinge groove 180 is coupled to the second hinge protrusion 130, without a separate fixing device.

In still another embodiment of the fixing means 190, it may be formed between the first hinge protrusion 120 and the second hinge protrusion 130, as shown in FIG. 4c. The fixing means 190 may comprises a magnetic body 191 on the luggage side trim 100. The magnetic body 191 may be installed on an outer or inner side of the luggage side trim 100. In this case, the magnetic body 191 may be a permanent magnet.

In addition, a portion 181 of a material that is able to be adhered to the magnet, for example, a small piece of iron plate, may be provided on each of both sides of the covering shelf 140. The piece of iron plate may be attached to an inner side of a side surface of the covering shelf 140, and may be formed through insert injection when injection molding is performed on the covering shelf 140.

The first hinge groove 170 may further include a reinforcing portion 171. The covering shelf 140 of a typical type may be manufactured by performing injection molding with a thin plastic material, and thus when the first hinge groove 170 is formed in the covering shelf 140, the first hinge groove 170 may be damaged by continued use thereof. To prevent this, the reinforcing portion 171 having the same groove as the first hinge groove 170 may be installed in the first hinge groove 170 to prevent the first hinge groove 170 from being damaged. In this embodiment, the reinforcing portion 171 may be a hinge bracket.

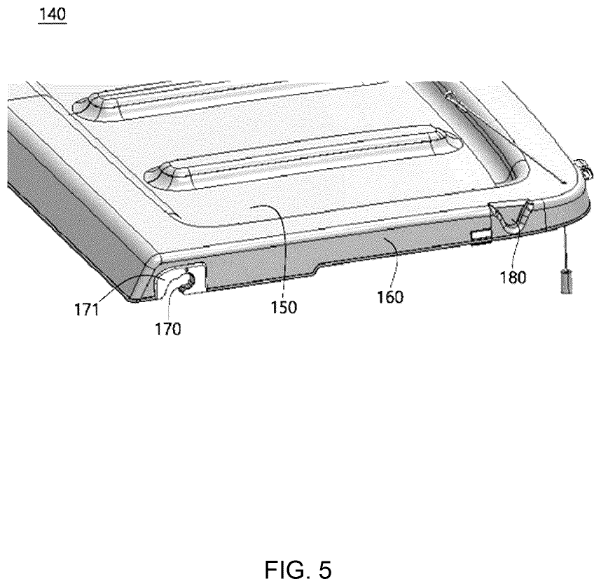

The first hinge groove 170 may be provided in the form that is diagonally recessed from the bottom, as shown in FIG. 5, and the second hinge groove 180 may be provided in a “V” shape.

The luggage side trim 100 may further include a seating portion 110 on which the covering shelf 140 is placed. The seating portion 110 may be formed at any position that has any height that allows the covering shelf 140 to remain horizontal while coupled to the second hinge protrusion 130. In this embodiment, the second hinge protrusion 130 may be formed at a slightly higher position than the seating portion 110, as shown in FIG. 1.

In addition, the seating portion 110 and the second hinge protrusion 130 may be spaced from each other by a predetermined distance in a horizontal direction. The predetermined distance may be desirably a distance by which a rear end of the covering shelf 140 and a front end of the seating portion 110 are not in contact with each other when the first hinge groove 170 of the covering shelf 140 is installed on the first hinge protrusion 120.

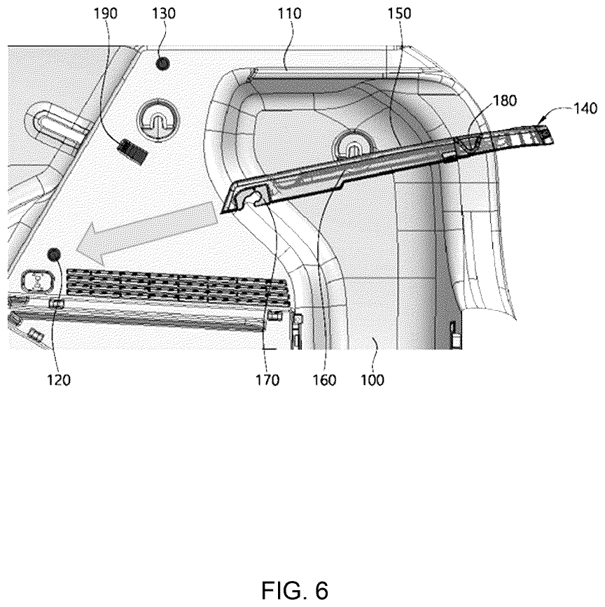

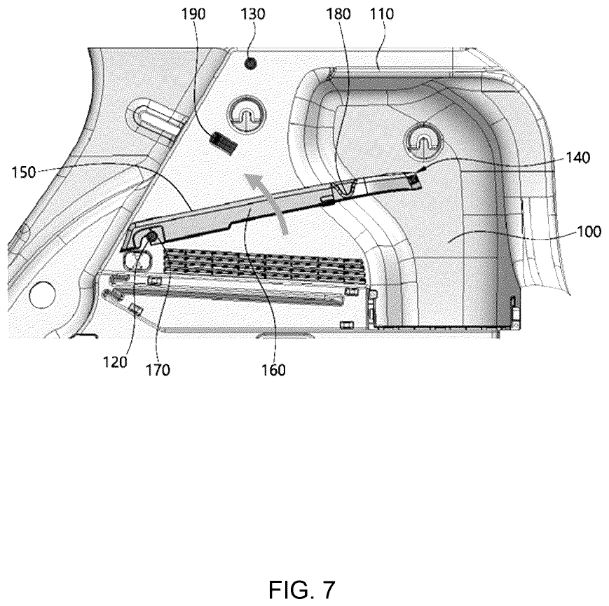

Thus, the rear of the covering shelf 140 is not in contact with the seating portion 110 when the second hinge groove 180 is coupled to the second hinge protrusion 130 after the covering shelf 140 is coupled to the first hinge protrusion 120, as shown in FIGS. 6 and 7, and thus it may not interfere with the coupling of the second hinge groove 180 and the second hinge protrusion 130.

### Second Embodiment

According to at least one embodiment of the present disclosure, a covering shelf fixture apparatus for fixing a covering shelf 220 to a luggage side trim 200 provided on each of both sides of a storage space of a vehicle may comprises a hinge protrusion 210, a support protrusion 250, and the covering shelf 220.

The hinge protrusion 210 may be formed on an upper portion of the luggage side trim 200.

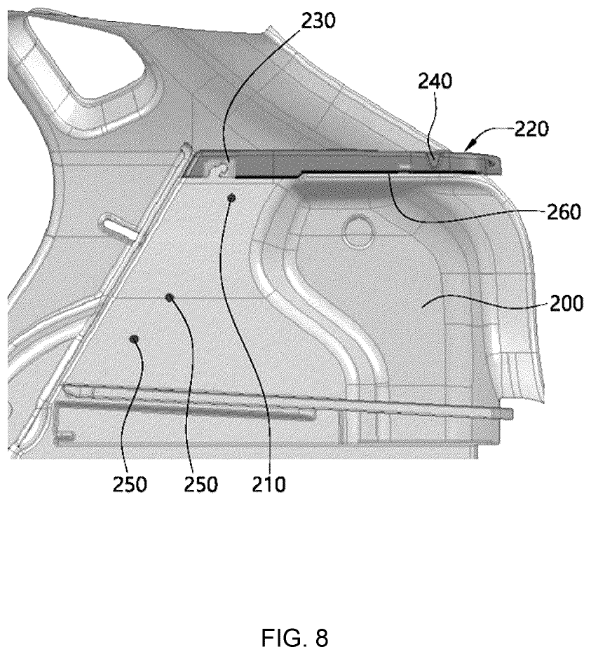

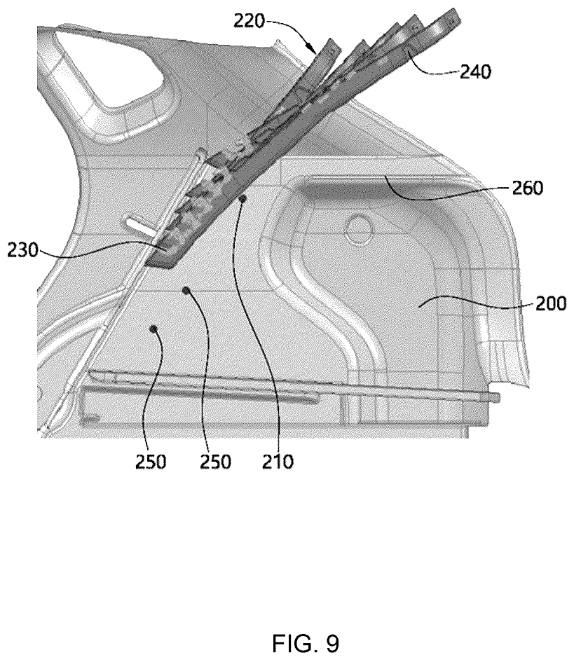

The covering shelf 220 may include a first hinge groove 230 and a second hinge groove 240. The first hinge groove 230 may be provided on each of both sides at a front end and may be placed on the hinge protrusion 210 without being coupled thereto when it is placed on a seating portion 260 formed on the luggage side trim 200, as shown in FIG. 8. The second hinge groove 240 may be provided on each of both sides at a rear end, and may be coupled to the hinge protrusion 210 as being separated from the seating portion 260 and received in a reversed state on a rear surface side of a backrest of a rear seat, as shown in FIG. 9.

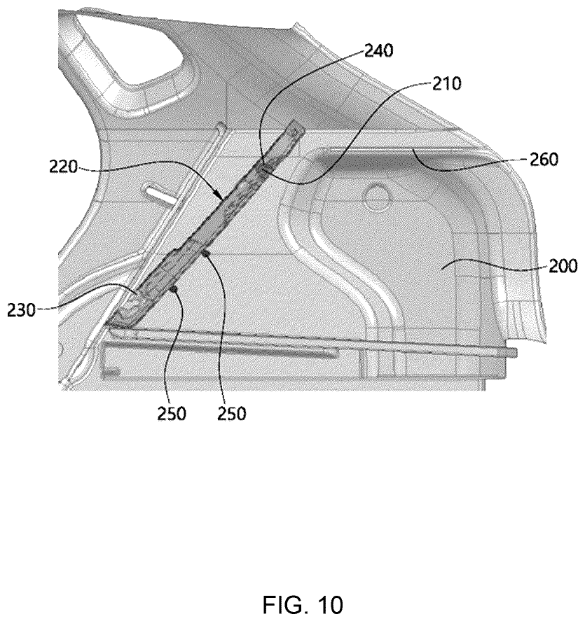

In addition, according to the second embodiment, the covering shelf fixture apparatus may further include a plurality of support protrusions formed on the luggage side trim 200, separated from the backrest of the rear seat by a predetermined distance. Referring to FIG. 10, the support protrusion 250 may serve to support the covering shelf 220 such that a lower portion of the covering shelf 220 is pressed closely against the backrest of the rear seat when the second hinge groove 240 and the hinge protrusion 210 are coupled. Although the support protrusion 250 is provided as two support protrusions in this embodiment, only one may be formed, depending on embodiments.

### Third Embodiment

According to at least one embodiment of the present disclosure, a covering shelf fixture apparatus for fixing a covering shelf 311 to a luggage side trim 300 provided on either side of a storage space of a vehicle may comprise a hinge protrusion 310, a support protrusion 340, and the covering shelf 311.

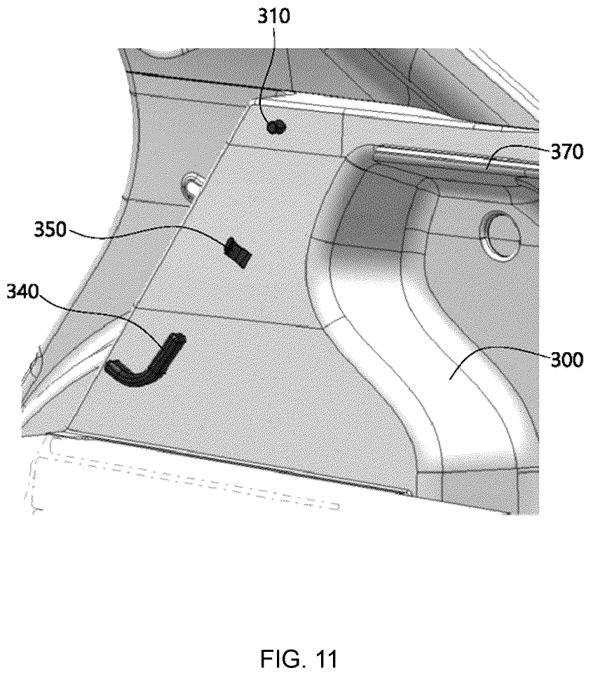

The hinge protrusion 310 may be formed on an upper portion of the luggage side trim 300 as shown in FIG. 11.

The covering shelf 311 may include a first hinge groove 320 and a second hinge groove 330.

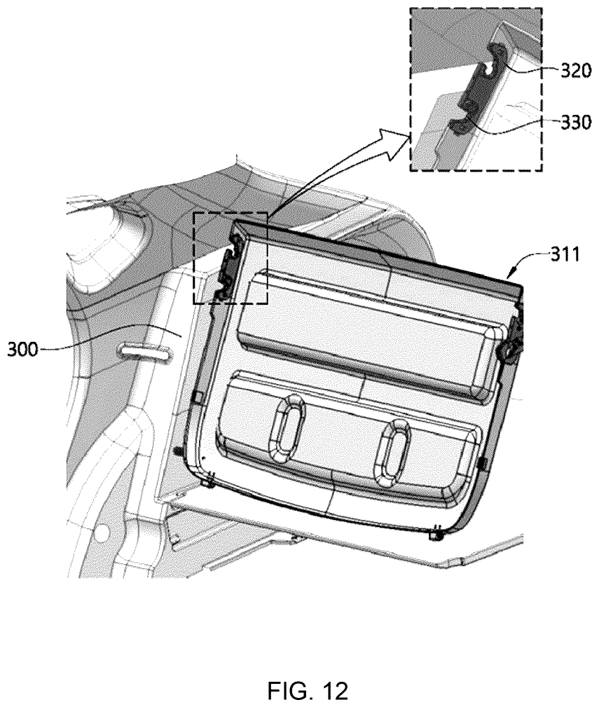

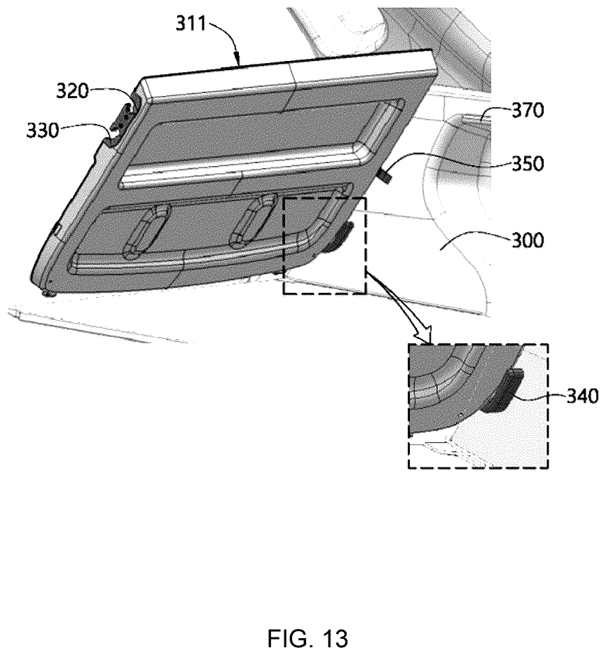

Referring to FIGS. 12 and 13, the first hinge groove 320 may be provided on each of both sides at a front end, and may be coupled to the hinge protrusion 310 when it is placed on a seating portion 370 formed on the luggage side trim 300. The second hinge groove 330 may be formed in an opposite direction to the first hinge groove 320, and may be coupled to the hinge protrusion 310 when it is received on a rear side of a backrest of a rear seat after being separated from the seating portion 370 in a reverse state to face upward.

The support protrusion 340 may be provided in an “L” shape, as shown in FIG. 11, and may serve to support an end of the covering shelf 311 such that a lower portion of the covering shelf 311 is pressed closely against the backrest of the rear seat when the covering shelf 311 is coupled as the second hinge groove 330 and the hinge protrusion 310 are coupled.

The covering shelf fixture apparatus according to the third embodiment may further include a fixing means 350 for fixing the covering shelf 311 to the luggage side trim 300, as shown in FIG. 13. The fixing means 350 may be provided between the hinge protrusion 310 and the support protrusion 340. The fixing means 350 may be a tension hook. The tension hook is described in detail above according to the first embodiment, and thus a more detailed and repeated description thereof will be omitted here.

Further, according to the third embodiment, the covering shelf fixture apparatus as another example may further include the support protrusion 340 formed on the luggage side trim 300 but spaced from the hinge protrusion 310 by a predetermined distance, and a coupling protrusion 360 to which the second hinge groove 330 is coupled. The coupling protrusion 360 may be disposed below the hinge protrusion 310.

When the covering shelf 311 is placed on the seating portion 370, the first hinge groove 320 may be coupled to the hinge protrusion 310, and when it is received therein, the second hinge groove 330 may be coupled to the coupling protrusion 360.

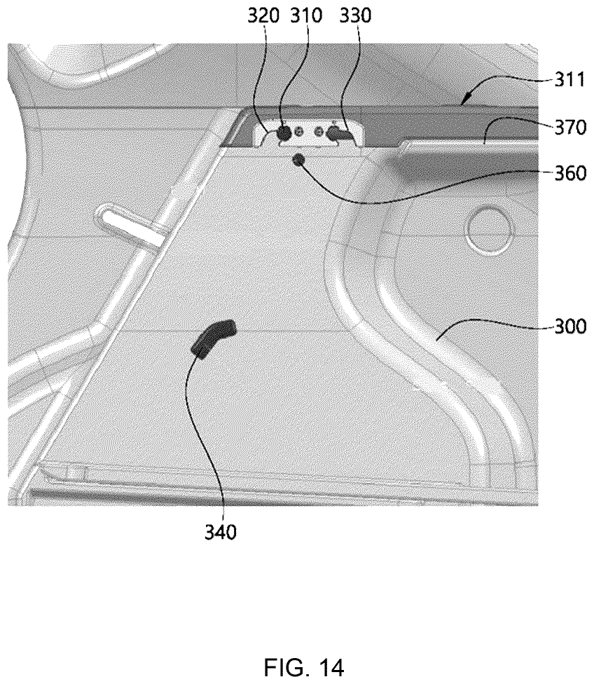

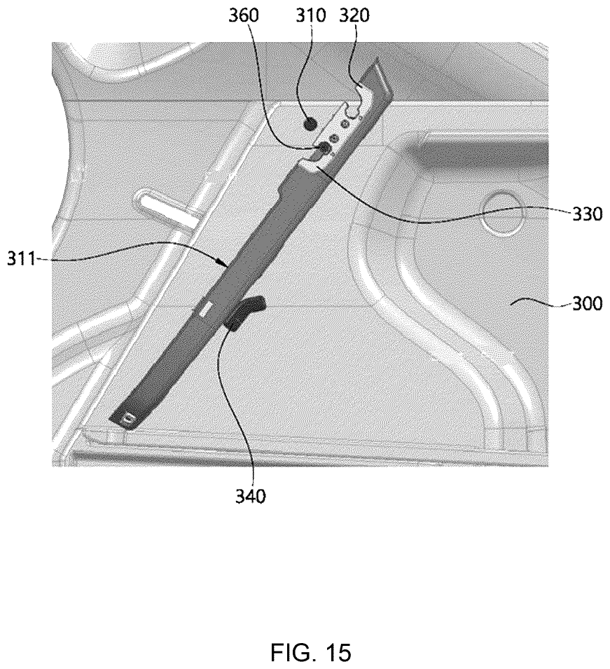

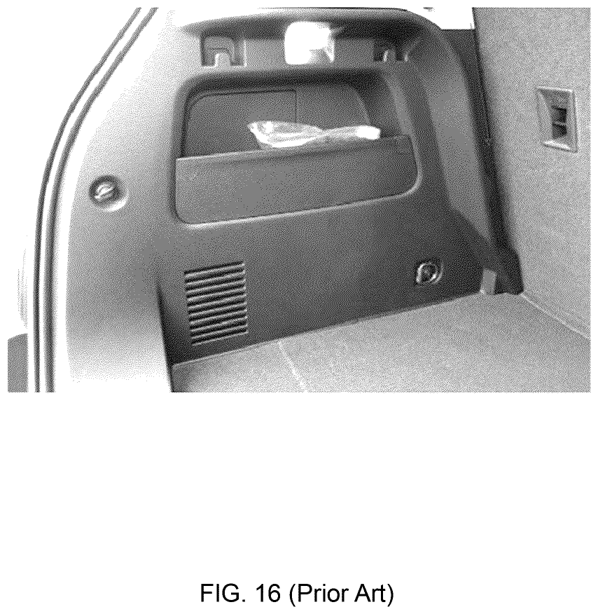

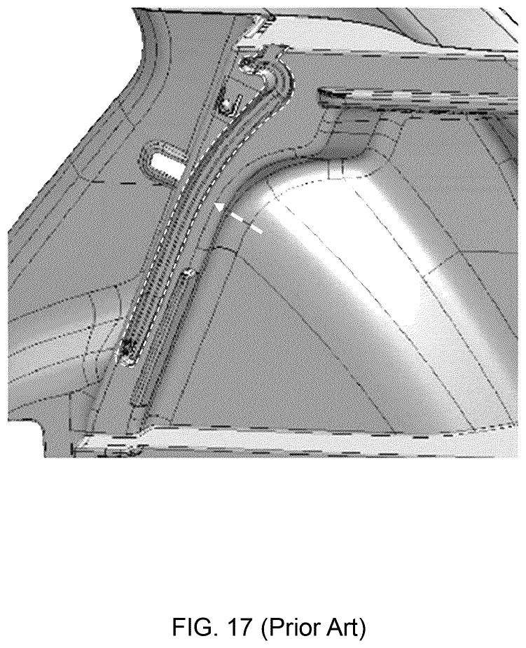

The support protrusion 340 may serve to support a middle portion of the covering shelf 311 such that the lower portion of the covering shelf 311 is pressed closely against the backrest of the rear seat when the covering shelf 311 is coupled as the second hinge groove 330 and the coupling protrusion 360 are coupled to each other, as shown in FIGS. 14 and 15.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. For example, features or aspects in each example are to be considered being applicable to similar features or aspects in other examples. Therefore, in addition to the above disclosure, the scope of the disclosure may also be defined by the claims and their equivalents, and all variations within the scope of the claims and their equivalents are to be construed as being included in the disclosure.

What is claimed is:

1. A vehicle, comprising:
a luggage side trim provided at each of both sides of a storage space located behind a seat inside the vehicle; and
a covering shelf configured to selectively cover the storage space,
wherein the covering shelf comprises a first hinge groove on each of both sides at a front end, and the luggage side trim comprises a first hinge protrusion configured to be coupled to the first hinge groove, and a fixing means configured to fix the covering shelf.

2. The vehicle of claim 1, wherein the luggage side trim further comprises a second hinge protrusion spaced from the first hinge protrusion by a predetermined distance, and the covering shelf further comprises a second hinge groove provided on each of both sides at a rear end.

3. The vehicle of claim 2, wherein the luggage side trim further comprises a seating portion configured to allow the covering shelf to be placed on to cover the storage space, and wherein the second hinge protrusion is positioned at a same height as the seating portion.

4. The vehicle of claim 3, wherein the seating portion and the second hinge protrusion are spaced from each other by a predetermined distance in a horizontal direction.

5. The vehicle of claim 2, wherein the fixing means is positioned between the first hinge protrusion and the second hinge protrusion.

6. The vehicle of claim 1, wherein the fixing means comprises a fixing protrusion extending from an inner surface of the luggage side trim.

7. The vehicle of claim 1, wherein the fixing means comprises a magnetic body provided on the luggage side trim and wherein the covering shelf further comprises a portion made of a material which is able to be adhered to the magnetic body by magnetic force.

8. The vehicle of claim 1, wherein the covering shelf further comprises a reinforcing portion on which the first hinge groove is formed.

9. The vehicle of claim 2, wherein the first hinge groove is formed diagonally from a bottom, and the second hinge groove is formed from a top to the bottom.

10. The vehicle of claim 2, wherein the fixing means comprises a magnetic body provided on the second hinge protrusion and the covering shelf comprises a portion provided in the second hinge groove and is made of a material which is able to be adhered to the magnetic body by magnetic force.

11. A vehicle, comprising:
a luggage side trim provided at each of both sides of a storage space provided behind a seat inside the vehicle; and
a covering shelf configured to selectively cover the storage space,
wherein each of the luggage side trim comprises a hinge protrusion on an upper portion thereof, and the covering shelf comprises a first hinge groove provided on each of both sides at a front end and configured to be coupled to the hinge protrusion when the covering shelf is placed on a seating portion of the luggage side trim.

12. The vehicle of claim 11, wherein the covering shelf further comprises a second hinge groove provided on each of both sides at a rear end and configured to be coupled to the hinge protrusion when the covering shelf is placed at a rear surface of a backrest of a rear seat after being separated from the seating portion.

13. The vehicle of claim 12, wherein the luggage side trim further comprises a plurality of support protrusions spaced from the backrest of the rear seat by a predetermined distance.

14. The vehicle of claim 11, wherein the covering shelf further comprises a second hinge groove formed in an opposite direction to the first hinge groove and configured to be coupled to the hinge protrusion when the covering shelf is separated from the seating portion and placed in a reversed state at a rear surface of a backrest of a rear seat.

15. The vehicle of claim 14, wherein the luggage side trim further comprises a support protrusion spaced from the hinge protrusion by a predetermined distance.

16. The vehicle of claim 14, wherein the luggage side trim further comprises a fixing means configured to fix the covering self to the luggage side trim, the fixing means located between the hinge protrusion and the support protrusion.

17. A covering shelf assembly for providing a storage space behind a seat inside a vehicle, the assembly comprising:
a luggage side trim provided at each of both sides of the storage space; and
a covering shelf configured to selectively cover the storage space,
wherein the covering shelf comprises a first hinge groove on each of both sides at a front end, and the luggage side trim comprises a first hinge protrusion configured to be coupled to the first hinge groove and a fixing means configured to fix the covering self.

18. The assembly of claim 17, wherein the luggage side trim further comprises a second hinge protrusion spaced from the first hinge protrusion by a predetermined distance, and the covering shelf further comprises a second hinge groove provided on each of both sides at a rear end.

19. The assembly of claim 17, wherein the fixing means comprises a magnetic body provided on the luggage side trim and wherein the covering shelf further comprises a portion made of a material which is able to be adhered to the magnetic body by magnetic force.

20. The assembly of claim 17, wherein the covering shelf further comprises a reinforcing portion on which the first hinge groove is formed.
